(19) United States
(12) Patent Application Publication
(10) Pub. No.: US 2017/0076630 A1
(43) Pub. Date: Mar. 16, 2017

(54) Optimizing Messages Sent to Diabetic Patients in an Interactive System Based on Estimated HbA1c Levels

(71) Applicant: LIvongo Heatlh, Inc., Chicago, IL (US)

(72) Inventors: Kimon J. Angelides, Houston, TX (US); Alex Bitoun, Houston, TX (US)

(21) Appl. No.: 14/851,675

(22) Filed: Sep. 11, 2015

(51) Int. Cl. G09B 19/00; H04L 29/08; H04B 1/3827; H04L 12/58

(52) U.S. Cl. CPC G09B 19/0092; H04L 51/26; H04L 67/26; H04B 1/3833; G09B 19/003

(57) ABSTRACT

Disclosed is a system of education, monitoring and advising on glucose testing, diet, exercise and drug administration using a device which is carried by the patient and which is capable of: blood glucose testing, displaying messages advising the patient to initiate blood glucose testing, and of recording the results of the test; of displaying advice or further queries based on analysis of the results, and displaying messages relating to advice, education and/or further queries based on the analysis. The messages are optimized based on their effectiveness in bringing about a favorable response in the patient's blood glucose level, estimated HbA1c level, or based on other clinical endpoints.

### FIELD OF THE INVENTION

The field is interactive patient management networks where on receipt of health parameter data from a patient, the network sends the patient particular directives which have increased probability of motivating the patient to take positive action.

### BACKGROUND

As one of America's deadliest diseases, and as there are over 20 million American diabetics, diabetes mellitus places a particularly high expense burden on the public healthcare system. Millions of Americans are not even aware that they have the disease, and an additional 50 million plus Americans have pre-diabetes. If the present trends continues, 1 in 3 Americans, including as many as 1 in 2 minorities born in 2000 will develop diabetes during their lifetime.

Diabetes is a group of chronic metabolic diseases marked by high levels of blood glucose resulting from defects in insulin production, insulin action, or both. While diabetes can lead to serious complications and premature death, effective treatment requires the diabetic patient to take steps to control the disease and lower the risk of complications.

About 5-10% of diabetics have Type I diabetes, while 90-95% have Type 2 diabetes. Type I is an autoimmune disease while Type II results from insulin resistance or inadequate insulin production. Type I has clear genetic markers while Type II is genetically heterogenous and therefore has a broader and less certain origin. Type II diabetes develops later in life, usually as organs & tissues lose their ability to respond effectively to insulin. Risk factors for Type II diabetes include older age, obesity, family history of diabetes, prior history of gestational diabetes, impaired glucose tolerance, physical inactivity, and race/ethnicity. As was mentioned above, African Americans, Hispanic/Latino Americans, American Indians, and some Asian Americans and Pacific Islanders are at particularly high risk for Type II diabetes.

The estimated cost of treatment totals 98 million dollars annually in the US. This problem is compounded by the fact that adult-onset diabetes is increasing at an alarming rate, and also striking at younger ages. Type II diabetes is showing up in young adults and even children. The disease often causes permanent damage to younger victims before they are diagnosed,

Uncontrolled diabetes leads to chronic end-stage organ disease and in the United States is a leading cause of end-stage renal disease, blindness, non-traumatic amputation, and cardiovascular disease. It is also associated with complications such as:
Heart Disease and Stroke (#1 cause of death for diabetics and 2-4 time higher than the general population)
High Blood Pressure (3 in 4 diabetics)
Nervous System Damage (can lead to amputations and carpel tunnel syndrome)
Pregnancy Complications (including gestational diabetes)
Sexual Dysfunction (double the incidence of erectile dysfunction)
Periodontal Disease

In the USA, over 85% of people aged 65 and over have diabetes, a fact that complicates their total health picture and often accelerates chronic end-stage disease, adding an enormous strain to the healthcare system. In addition, there are correlations of higher diabetes incidence with smokers, and Alzheimer's patients.

Poor control of blood-glucose in diabetes dramatically increases the risk of heart disease, stroke, amputations, blindness, renal disease and failure, impotence, and many other diseases—better control of blood-glucose levels greatly mitigates these complications. Coupled with proper education, nutrition, maintenance of stable blood-glucose levels, and regular exercise, many Type 1 and 2 diabetics can minimize the effects of the disease.

With the growing problem of diabetes in developed and developing countries comes a growing need for convenient blood glucose monitoring, and convenient methods for analysis and treatment based on the monitoring. Diabetics need to monitor their blood glucose multiple times a day and record this information, which is analyzed, along with other parameters such as quantity of exercise and their diet, and then use the results to determine food intake, adjust the dosage of insulin and/or other therapeutic agent, and to recommended exercise intensity or cessation. Compliance with the monitoring, diet and exercise regimes is a challenge due to their complexity and temptation to avoid the recommended diet, which is low in simple sugars, and the recommended exercise regime.

A hand-held, portable wireless device, linked to and interactive with a server and with personal health monitors for the user, can be used assist in compliance by reminding the patient of the need to test periodically, by logging the blood glucose test results and the associated meal information and the carbohydrates ingested and the patient feelings, (and storing the results in a user friendly display form as averages and other analysis), and also by providing selected advisory and educational messages, and providing sharing with select health monitors and other selected parties, all with the aim to increase compliance with the recommended the monitoring, diet and exercise regimes. Maintaining an optimal diet and exercise program is extremely important but also problematic for most diabetics. Messages regarding diet, exercise and general education and warnings can be helpful to keep a patient on track.

In the course of selecting messages, the most reliable information about the patient's metabolic state be used to determine selection of messages providing advice and education for the user.

Glucose meters are universally used in the self-management of diabetes in a variety of settings. The accuracy of blood glucose measurements is a critical for treatment decisions when aiming for glycemic control. Over the last several years, there has been extensive work on establishing the relationship between glycemic control and HbA1c, which is the primary indicator used for assessing glycemic control and for determining likelihood of particular outcomes, positive or negative, and adverse events including morbidity and death. HbA1c is normally in the 5 to 6% range, but in diabetics, it can reach 14%. HbA1c is also an important indicator of efficacy for various clinical treatments—where efficacy is often based on lowering of the HbA1c value over time with statistical significance (p≦0.5). The HbA1c value is also directly related to projected health-care cost for a diabetic, as well, and therefore is used to govern management of a diabetic population.

A large number of studies have shown that HbA1c is strongly associated with the preceding mean plasma glucose over the previous weeks and months. HbA1c is determined based on the mean plasma glucose in the prior period, based on a known relationship between HbA1c and mean plasma glucose. Easily obtaining accurate HbA1c levels is important so that patterns can be recognized and treatment and self-management decisions can be taken with greater confidence.

To date, several algorithms have been proposed that can calculate the HbA1c from the mean blood glucose, by providing different weighting for the circulating blood glucose, the kinetics of non-enzymatic glycosylation of hemoglobin, and the half-life of red blood cells. These algorithms have proven to be accurate and robust and applicable to the dynamic tracking of HbA1c and to provide a real-time estimation of HbA1c using routine self-monitored blood glucose data. The reliability of the estimation of HbA1c was sometimes not well-matched to patient data, in subsequent unpublished studies. Accordingly, an algorithm that provides a more reliable result is needed.

Some of the problems with the existing HbA1c estimation algorithms, is that usually, all blood glucose level determinations are used, i.e., both pre- and post-prandial, because the existing blood glucose meters are unable to provide accurate association of the BG values to meals consumed and time of consumption. It is clinically important to know the fasting blood glucose values over an extended period (several days or more), as well as daily variations in these values including those associated with meals, for establishing HbA1c values reliably. Allowing determination of whether a particular blood glucose level is pre or post-prandial allows applying a correction factor to either (though generally to the post-prandial blood glucose level) to get a more accurate blood glucose determination. In the alternative, as HbA1c is the more often relied on indicator for clinical outcomes, the HbA1c formula includes a normalization factor or allows for adding one, to normalize for pre and post prandial measurement differences in blood glucose level, as determined by a glucometer in a self-administered test.

Since more accurate determination of HbA1c leads to improved diabetes control and improved clinical outcomes for patients, this determination is desirable in a system where one is tracking outcomes, reporting outcomes, and using the improved outcomes to recruit additional patients to track their HbA1c using a glucose meter which associates BG levels with meals and meal times over an extended period. The known algorithms for estimating HbA1c from BG levels include:
(a) “estimated average HbA1c”=Average blood glucose (mg/dL)+46.7/28.7 which is from Nathan et al., “Translating the A1C assay into estimated average glucose values” Diabetes Care (2008) 31(8): 1473-78.
(b) “Running HbA1c” δHbA1c/δt=−1/τ(HbA1c−f(SMBGt) where
   f(SMBG)=MAX(0.99*(4.756+0.0049*mPo(t)+CalA1c), where mPot is the average fasting glucose value over the past 6 days, and SMBG is the self-monitored blood glucose levels. See Kovatchev et al., “Evaluation of a new measure of blood glucose variability in diabetes” Diabetes Care, 2006 29(11):2433-8; See also Kovatchev, B. et al (2014), “Diabetes Technology and Therapeutics” 16: 303-309.

Where a user is provided feedback, advice and education in the form of messages from a server to a personal device, having the messages based on a more reliable measure of HbA1c, and having the messages which are sent selected based on the HbA1c in combination with other factors, including one or more of BG level, ketone level, time from last meal, last meal content and exertion level allows for more effective advice for the user, making the management system more likely to lead to a positive clinical outcome.

### SUMMARY OF THE INVENTION

Disclosed is a process of increasing patient compliance, especially for diabetics, with a recommended diet and exercise regime, by determining which among a group of messages advising the patient about food intake, timing of food intake, ceasing or commencing exercise and messages relating to the benefits or detriments of particular diet and exercise choices, and/or sending further queries, based on factors including a more reliably determined Hb1Ac level. The advisory messages can include messages advising the patient to test for a chemical or biochemical indicator, including blood glucose level, ketone level, in vivo drug or insulin concentration, blood pressure, or gene expression level. US Publ'n No. 20130035563 (incorporated by reference) lists numerous messages in the category of “exemplary educational messages” although many of those messages meet the definition herein of “advisory messages,” or are in another of the four categories in Table II below.

Preferred user devices and interactive systems for use with the invention include those described in U.S. Pat. No. 8,066,640 and US Publ'n No. 20130035563 (both of which are incorporated by reference). In brief, these references together describe a system of education, monitoring and advising on glucose testing, diet, exercise and drug administration using a device which is lightweight and portable (and easily carried by the patient) and which is capable of: blood glucose testing, displaying messages advising the patient to initiate blood glucose testing, and of recording the results of the test; of displaying advice or further queries based on analysis of the results, including advising for testing ketones if the blood glucose level is above a threshold level; analyzing other blood glucose-related and health-related information and personal information, including patient-identifying information and patient preferences (particularly for diet and exercise) and patient limitations (can't run, for example) which can be input by the patient periodically or input and stored; and of displaying advice, education and/or further queries based on the analysis.

The process is used in an interactive system where patient information (which can be initially input and updated constantly), including information about patient medications, scheduling and dosage, personalized information about suitable exercise, foods and medications, as well as contemporaneous information about diet and exertion level, is transmitted wirelessly to a server for analysis and determination of which messages are to be sent to the patient.

The most desired range of blood glucose level is 90 to 125 mg/dL. Under 90 mg/dL would be hypoglycemic and a range of 125 to 180 mg/dL would represent initial stages of hyperglycemia. If blood glucose level is over 180 mg/dL it represents hyperglycemia, and at over 250 mg/dL, it is severe hyperglycemia and ketone levels must be monitored and brought back to normal, if outside an acceptable range. Accordingly, when blood glucose level is below 90 mg/dL or above 180 mg/dL it is determinative in selection of particular advisory messages, e.g., “eat” if the level indicates hypoglycemia and “don't eat, inject insulin” if the level indicates hyperglycemia. However, for messages sent for blood glucose (“BG”) levels within the 90 mg/dL to 180 mg/dL range, where there is no acute health risk, the message selection can be either based solely or partially on the running HbA1c level. In such cases, the running HbA1c level gives a more reliable indicator of user status.

Instead of estimating HBA1c from only fasting BG levels, and ignoring fluctuations (especially those associated with meals), the estimation by the methods described herein is based on a mean plasma glucose level, to account for fluctuations. Preferably, the mean blood glucose level is determined over several hours, or one day, or more.

In the invention, if there are improved outcomes of patients resulting from a combination of the improved reliability of the HbA1c determination with any of: continuous monitoring of metabolites other than blood glucose level; of food consumption; of exertion level; providing personalized education and other advice on insulin and drug administration, food consumption and timing, and exercise type and intensity—then such results are publicized to do one of: (i) increase patient compliance with the recommended diet, exercise, and/or testing, drug administration, and improve patient clinical outcomes; or (ii) to recruit new patients into the system, and thereby improve the outcomes and overall health of an increasing proportion of the diabetic patient population. The use of improved clinical outcomes to encourage improved compliance with a recommended diet and exercise regime, and their use to recruit additional patients to use the system, is discussed in US Application Publication No. 2014/0363794 A1 (incorporated by reference).

The invention includes making a more reliable estimation of running HbA1c over several hours, one day, several days or up to about one month or more. The effect of fluctuations in BG level on HbA1c, including significant fluctuations associated with pre and post prandial BG level are reduced by averaging and regression analysis, so that the BG and HbA1c levels determined will be more reliable. As a result, the ability to more reliably predict clinical outcomes is improved, and the effect is to encourage improved compliance with a recommended diet and exercise regime, and to enhance recruiting additional patients to use the system. Also the ability to select an advisory or educational message from a message bank based on patient status, which is more likely to encourage a patient to take a beneficial action, is improved. See U.S. application Ser. Nos. 14/307,906; 14/338,221 (both incorporated by reference).

The more accurate determination accounts for aging and elimination of erythrocytes, and their loading and carrying efficiency for HbA1c. The new algorithm for HbA1c estimation is:

HbA1cₜ=Σⁿₜ₌₀((1/t)·(a+b·MPGₜ))/n

Where:

n=estimated lifespan of red blood cells (erythrocytes) in days;

a=HbA1c constant=e−^{kT}, where k is the first order rate constant for the nonenzymatic attachment of glucose to HemoglobinA1, and T is the length of time since exposure of glucose to HemoglobinA;

b=Mean Plasma Glucose to HbA1c multiplier;

MPGₜ =Mean Plasma Glucose level on day t; and

HbA1cₜ=HbA1c level on day t.

The new algorithm helps correct for several different events which affect reliable HbA1c estimation, particularly: the estimated lifespan of red blood cells (erythrocytes) in days; and accounting for the fact that nonenzymatic attachment of glucose to HemoglobinA1 progresses under a rate constant over time. The algorithm was derived from published values of A1C formation at different blood glucose concentrations at a particular time, t. These were subject to a least square linear regression on the different concentrations (linearity was assumed, as the higher the blood glucose concentration the more is absorbed by hemoglobin, and the faster the formation). The algorithm describes the formation of HbA1c as a function of glucose concentration, as a first order reaction based on e^{-kT}; where k is the rate constant. It should be understood, however, that other methods (including conventional methods) of estimating Hb1Ac are also within the scope of the invention.

In one aspect, the invention involves selecting messages to be sent to a patient from a message bank, where the selection is based on a number of factors, including estimated HbA1c level. In another aspect, the effectiveness of a group of messages directing the patients to monitor BG levels can be optimized based on how frequently patients test their BG levels following receipt of such messages. Similarly, the effectiveness of a group of messages in directing the patient to exercise can be optimized based on results from an accelerometer carried by the patient (which is preferably part of the device) which shows the patient movement and exertion level.

Messages can also be optimized based on: (i) their effectiveness in reducing co-morbidities and physiological risk factors; (ii) their effectiveness in inducing compliance with medication and other prescribed regimes; (iii) their effectiveness in regulating levels of other biometric parameters besides BG levels including HbA1c, and LDL; and (iv) their effectiveness in inducing adherence to good diabetes care practices, like monitoring of eye, foot, wound and heart health. The messages for each of these categories (i) to (iv) would be weighted based on their effectiveness (which could be measured by a number of methods). Effectiveness of combinations of messages could also be determined against combinations of parameters—for example, it might be that messages relating to category (iv) also induce patient compliance with category (ii) parameters. Or, a combination of messages directed to induce compliance with category (ii) an (iv) also increase compliance with category (i).

The effectiveness of optimizing the messages in controlling BG or HbA1c levels can be advertised or publicized to recruit additional patients into the system, and thus increase the number of patients benefitted.

The invention is described further in the flow charts, where exemplary sets of steps to be executed by a computer are set forth.

### BRIEF DESCRIPTION OF THE FIGURES

FIG. 1 is a flow chart showing optimizing messages to be sent to patients based on their HbA1c levels following receipt of particular messages.

FIG. 2 is a flow chart showing optimizing messages for a particular user including accounting for the number of times the message was sent to the user, based on his/her HbA1c levels following receipt of particular messages.

FIG. 3 depicts a system and algorithm for optimizing messages which are most effective in maintaining the patient's BG level within, or moving it into, a desired range.

FIG. 4 depicts a system and algorithm for optimizing messages which are most effective in maintaining the patient's exertion level within, or moving it into, a desired range.

FIG. 5 depicts a system and algorithm for optimizing messages which are most effective in prompting a user to test their BG level.

### DETAILED DESCRIPTION

Preferred user devices and interactive systems for use with the invention include those described in U.S. Pat. No. 8,066,640 and US Publ'n No. 20130035563 (both of which are incorporated by reference). In brief, these references together describe a system of education, monitoring and advising on glucose testing, diet, exercise and drug administration using a device which is lightweight and portable (and easily carried by the patient) and which is capable of: blood glucose testing, displaying messages advising the patient to initiate blood glucose testing, and of recording the results of the test; of displaying advice or further queries based on analysis of the results, including advising for testing ketones if the blood glucose level is above a threshold level; analyzing other blood glucose-related and health-related information and personal information, including patient-identifying information and patient preferences (particularly for diet and exercise) which can input by the patient periodically or input and stored; and of displaying advisory and educational messages, and/or further queries based on the analysis.

As the device's computing power or access to full patient information is limited, and because the ability of health care professionals to provide advice is also desired, the device is preferably linked wirelessly to a server that performs some or all of the analysis and information storage described above. In the case of employing a server, the BG test results and preferably also information about food intake, exertion and patient feelings and symptoms, are transmitted to the server. The device receives the results of the server's analysis in the form of queries, advice and educational messages. The wireless link to the device also provides the ability for feedback, advice and/or intervention from appropriately experienced health care workers, as necessary and appropriate.

The device preferably also includes the ability to test ketone levels and record the results, track timing of food consumption and foods, particularly carbohydrates, consumed, and a pedometer or accelerometer to track patient exertion and estimate total calories expended in exercise.

The analysis from the server is then used to select from a library of messages to send to the device (and the user). The messages relate to advice on further testing, food consumption and exertion, as well as general diabetes education, and are preferably suitable for display on a small screen, typical of a hand-held device—meaning the messages are necessarily compact. The messages user's receive are optimized based on their effectiveness, where effectiveness is based on the patient's HbA1c level for messages relating to diet and exercise and general advice and warnings. The effectiveness based on the patient's HbA1c level is a clinically relevant reflection of the effectiveness of such messages in motivating users to adhere to the recommended diet and exercise. Effectiveness could also be based on recognized clinical endpoints associated with diabetes.

For message which prompt the user to test BG levels or other indicators, effectiveness can be based on the lag time to the next BG test (or other test). Effectiveness of messages prompting the user to exercise (or to cease exercise) can be optimized based on the user's exertion level following such messages, as measured by the pedometer on the user's device.

It is noted, however, that in any message optimization system, certain messages are prioritized where the analysis shows that the need for certain messages much outweighs that of others—in the case, for example, of acute conditions. For example, where BG level indicates hyperglycemia (over 180 mg/dL) or severe hyperglycemia (over 250 mg/dL), particular messages, e.g., “inject insulin” “commence exercise” “check ketones” “don't eat” should be preferentially selected, as the patient is in an acute state. Similarly, certain messages should be prioritized when the patient is hypoglycemic or severely hypoglycemic (less than 70 mg/dL; see US Publn No. 20130035563, incorporated by reference). The messages in the event of severe hypoglycemia are preferably messages instructing on the “rule of 15” described in US Publn No. 20130035563.

Even where certain messages are prioritized, however, the effectiveness of prioritized message sets can be optimized against returning BG levels to normal ranges, or closer to normal ranges, or against other indicators (e.g., ketone levels) or against established clinical endpoints. An example of optimizing prioritized messages is instead of “commence exercise”: “start walking now”; or instead of “don't eat,” the message could be “eat no food for the next ______ hours.”

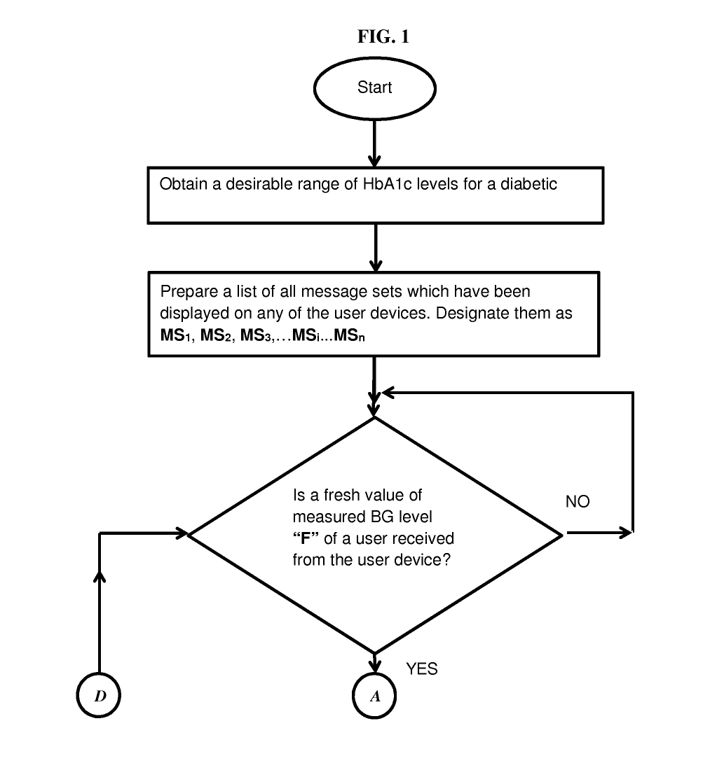

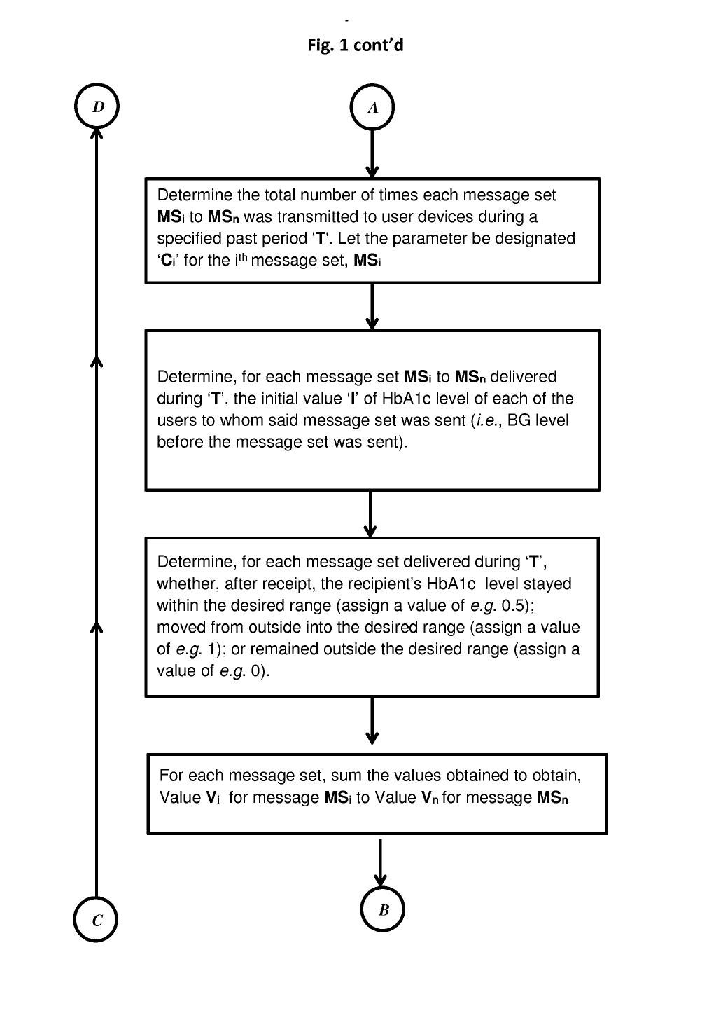

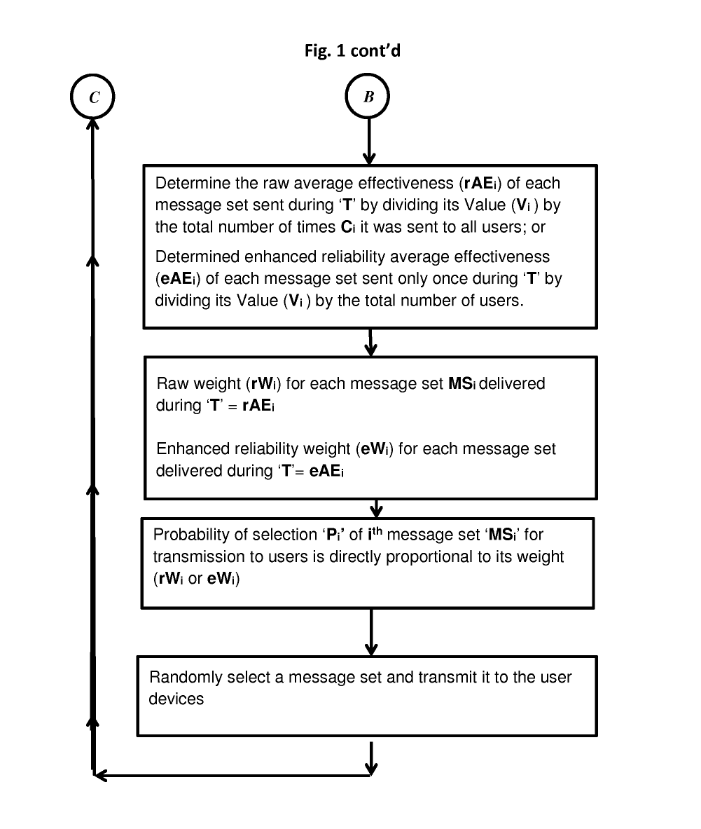

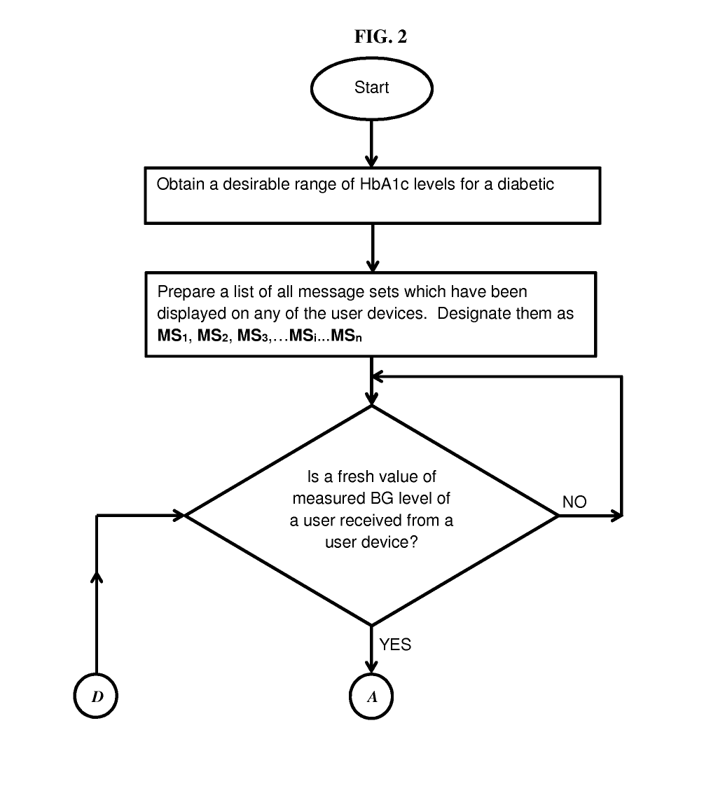

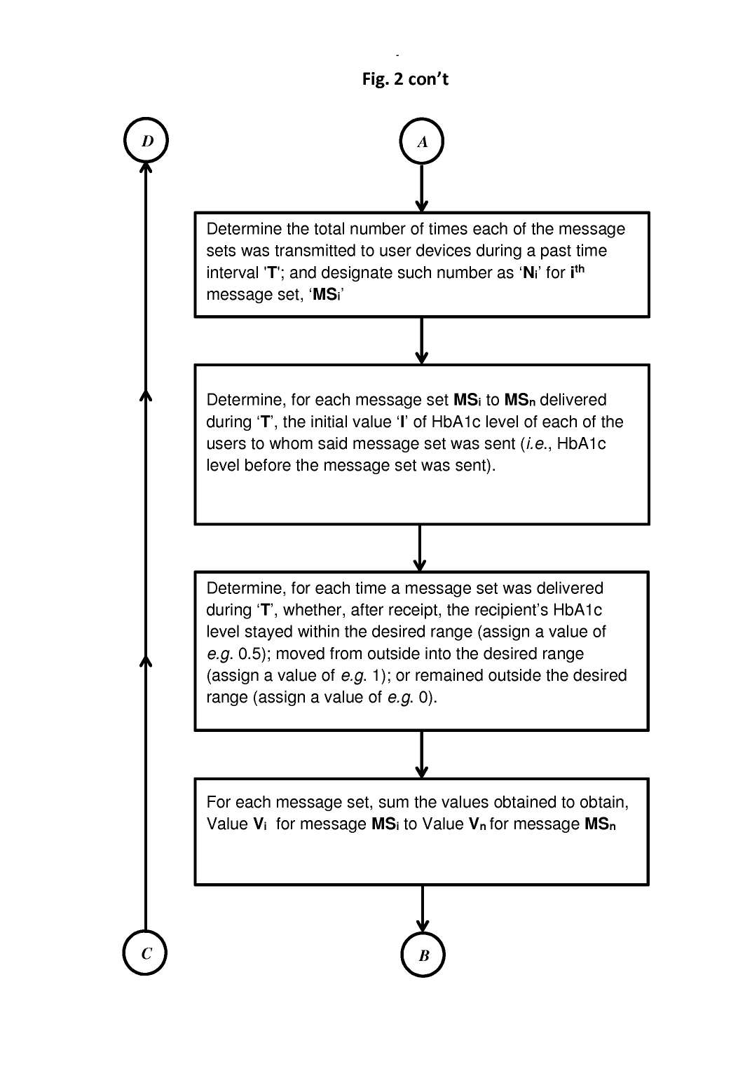

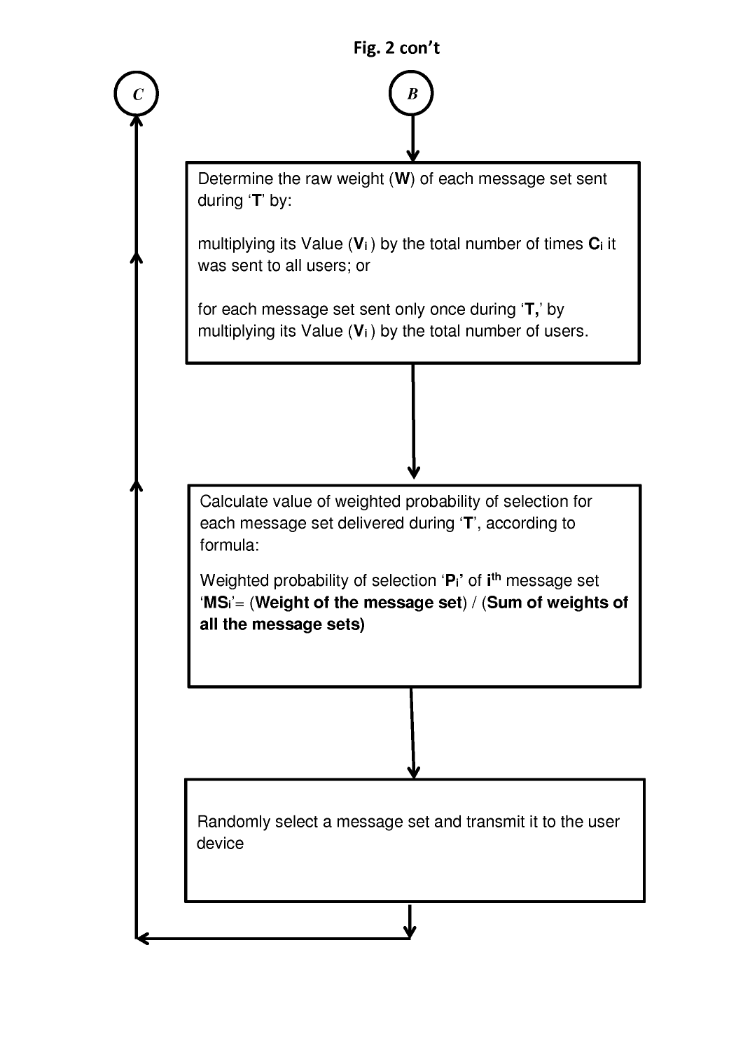

Optimization of messages can be performed a number of ways (i.e., by a number of different algorithms and statistical analysis methods) including by following the steps set forth in FIGS. 1 and 2. The steps outlined in FIGS. 1 and 2 describe a continuous message optimization loop, where the message sets are continuously optimized based on newly received BG levels (provided the BG levels are received within time Tₚ after display of a particular message set MSᵤ).

Message sets are weighted based on their effectiveness in causing positive changes in the patient's HbA1c level, such that more effective message sets are more frequently selected for display on patients' devices. A similar weighting based on positive effect could be used where another indicator level (e.g., ketone level) or a clinical endpoint is used in determining effectiveness of messages.

If one starts the optimization process with a library of message sets and of BG level responses from patients who received the message sets, then the first cycle through the process of FIGS. 1 and 2 (which follows weighting of more effective messages and preferentially sending them based on their weight) provides an immediate clinical benefit for the patients. Further optimization by continuing the process through subsequent cycles would continuously provide even more effective messages to more patients, to continuously increase the benefit to more patients. Determining whether message sets' effectiveness is statistically significant (i.e., if some sets or orderings or timings of messages improve HbA1c levels in a statistically significant manner, with a p value of 0.05 or less) would be a further verification of efficacy of such messages. Such determination could also be performed in the system described herein.

In an alternative method where there is no continuous optimization, one could do an initial review of the library and of HbA1c levels from patients who received the message sets, and select the message sets that were most effective (whether their effectiveness was statistically significant or not)—and send only those message sets subsequently. Similarly, one could run the process for a designated number of cycles and then select the only the most effective sets for sending to patients subsequently. These alternatives limit the ability to include new messages or other changes in message ordering or timing, which may be a disadvantage. Patient responses to optimized messages my change over time, and the ability to test new messages and formats continuously would seemingly be advantageous.

Besides HbA1c level, other clinical endpoints against which message sets can be optimized are death or diabetic disease markers, including non-healing wounds, hypertension, neuropathy, nephropathy, stroke, gastroparesis, ulcers, heart disease, and cataracts. The optimization can be based on the Kaplan-Meier estimator against death or an endpoint associated with any of the foregoing diseases/conditions. In the case where one starts with a library of messages sent to diabetic patients over a prior period and information about whether they reached death or another endpoint associated with any of the foregoing diseases/conditions, these messages can be immediately optimized based on the Kaplan-Meier estimator, and a p value for particular messages or message sets can be derived, by either comparison among patients in the database or against established or known values of progression to the endpoint(s). Messages or message sets that are effective in prolonging reaching an endpoint with a p value of 0.05 or greater, which are those shown to be beneficial in a statistically significant manner, can be designated to be always sent (i.e., be exclusively selected). Alternatively, the most effective messages (whether their effectiveness is statistically significant or not) can be more heavily weighted in subsequent loops of the process where the optimization is a continuous function (as in FIGS. 1 and 2).

Referring to FIGS. 1 and 2, another way to determine average effectiveness of messages (AEᵢ of Mᵢ), rather than to average “how effectively did the reported HbA1c level of a user move to within or stay within a desired range” (as shown), is to determine how much (on average) the messages caused patient HbA1c level to move towards that range. That is, messages which are associated with moving HbA1c level from further out of range to closer to the desired range are more effective and are weighted in accordance with the amount of such movement (or change).

Another variation on the process in FIGS. 1 and 2 is to use other math functions besides weighting, including Kaplan-Meier or other regression analysis, to determine average effectiveness. A number of algorithms can be used to optimize messages or message sets.

Although FIGS. 1 and 2 specify ranking “the message sets in descending order of respective values of probability of selection,” this may not be a necessary step—though it can facilitate selection when using software-driven methods of selection.

Once a library of messages is established together with a database of patient responses, the process in FIGS. 1 and 2 can be used to optimize message sets for particular segments of the patient population (where segmenting can be based on, for example, age, sex, education level or ethnicity). The population segment the patient belongs to can be identified from the patient information in the database (note that the patient inputs personal and identifying information and preferences into the server's database).

The patient population could also be segmented based on their preferences, including their diet and exercise preferences. Monitoring of the message library and patient responses can allow such segmenting, as patient preferences are preferably entered into the database on the server, and messages to such patients can then be correlated with effectiveness to optimize them. Patients with preferences for particular foods or exercises, may well be more responsive to certain messages regarding diet and exercise—making optimization for such patient segments desirable.

As noted, the messages can be optimized across the message characteristics, including language choices, punctuation and grammar, font and format. Optimization can be of message sets or individual messages. For individual messages, their ordering and timing of sending them (in relation to each other) can also be optimized, following optimization of the message characteristics. For message sets, the optimization can further include the ordering and the timing of the sending of the different messages in each set, increased frequency of repetition for some messages in a set, and can further include the timing of and the order of sending of different sets in relation to other sets. See U.S. application Ser. No. 14/338,221, incorporated by reference.

Message sets could also be divided into subparts based on whether they relate to prompting diet or exercise, or whether they are general educational content messages. The general educational content messages have greater numbers of possible choices than other messages, and thus a greater number of variable terms. It might be desirable to continue to vary and optimize educational messages (in a message set) after the diet and exercise messages in the set have been optimized and certain ones selected. Certain educational messages could also prioritized along with certain diet and exercise messages which are prioritized—when, for example, BG or HbA1c levels are far outside the desired range, as described above. Alternatively, when diet and exercise messages are prioritized, the entire educational message library could still be optimized—i.e., no educational messages are prioritized out of the library.

As noted, the effectiveness of messages prompting exercise can be among those monitored in determining effectiveness in controlling HbA1c levels. Messages prompting exercise can also be separately monitored based on the patient's change in exertion level during a specified time following the message display. Where multiple messages or where message sets are sent, the effectiveness can be determined over a longer period—for example, effectiveness in increasing exercise time or intensity over a month-long period can be determined.

For devices including a pedometer, the exertion level is preferably determined by the pedometer and transmitted for analysis. Or, exertion level can be by (or pedometer results can be supplemented by) patient reporting. All the segmenting and message variation applicable to optimizing messages about HbA1c level could also be used to segment (among populations) or vary (including variation of timing of) messages prompting exercise.

The algorithms for determining effectiveness of messages prompting exercise can be similar to those shown in FIGS. 1 and 2—i.e., a continuous loop where the initially more effective messages are weighted and sent more frequently than the less effective ones. Again, rather than a continuous loop it can be preferred to simply select the most effective messages (either from a library of responses or after a certain number of cycles through the loop) and use only those messages (or only those message sets) going forward. Other functions and algorithms for determining effectiveness besides the weighting method in FIGS. 1 and 2 can also be applied to messages prompting exercise.

Messages prompting the user to test BG levels would normally be separately monitored for effectiveness—based on whether the test was performed within a specified period following sending the message. All the segmenting and message variation applicable to optimizing messages about HbA1c level could also be used to segment (among populations) or vary (including variation of timing of) messages prompting testing.

In FIGS. 1 and 2 it shows that without such a BG level test, there are no results available to determine message effectiveness in moving HbA1c level to the desired range. Without a BG level test in the process shown in FIGS. 1 and 2, the message effectiveness would be that determined solely from library of messages and patient responses. Thus, one variation on the process in FIGS. 1 and 2 is to factor in the number of BG level tests which are used in determining average message effectiveness—in order to increase reliability of the effectiveness determined.

Referring to the prioritization of messages, as the personal profile changes over time (e.g., food likes and dislikes may change; exercise preferences and exclusions and physical limitations likely would change; state of general health and co-morbidity risk likely would change; medications also likely would change) the messages which are prioritized or deselected in the message bank would change in a corresponding manner. For example, messages would not be sent recommending extreme exertion after a heart attack. Messages would not be sent recommending a medication which is no longer prescribed, but messages would be prioritized to recommend taking a newly prescribed medication, as scheduled. Similarly, changes in the state of general health and the co-morbidity risk could result in certain foods, activities and medications being contra-indicated, or more strongly contra-indicated (stopping smoking after a heart attack), and messages could be prioritized to recommend avoidance of such foods, activities and medications.

In the system of prioritization and deselection of messages described above, prioritization of messages in the message bank can include any of the following: the message is sent once; the message is either sent at a specified frequency for a set period and/or until the requirement it requests is filled; the message is sent at a specified frequency indefinitely. De-selection of messages in the message bank can include any of the following: the message is never sent again; the message is not sent for a specified period and/or until a countervailing concern has been rectified; the message is sent again at specified time(s) and/or frequencies.

Whether or not prioritization or deselection of certain messages is indicated for a patient, message optimization, as described above, can be implemented; or a combination of prioritizing or deselecting certain messages while optimizing or otherwise changing the selection frequency of other messages can be implemented. The circumstances where combinations of prioritizing/deselecting some messages and optimizing other messages are appropriate include:
where preferences of the patient change, then certain messages directly relating to reinforcing the new preferences are prioritized and other messages counter to the new preferences are deselected, and then other messages in the bank can be optimized based on their effectiveness in prompting patient responses, in view of the foregoing changes in the message bank (from prioritization and deselection);
when HbA1c levels or levels of other chemical or biochemical indicators are out of range, specific advisory messages from categories (i) and/or (ii) (in the Summary) would be prioritized, and certain educational messages (preferably) would be prioritized—i.e., those advising of risks of out of range levels. Other educational messages could also be selected based on other factors, and frequency of sending them can by controlled by an optimization procedure;
when the patient fails to test BG levels or levels of other chemical or biochemical indicators at the recommended interval, advisory messages from category (i) (in the Summary) would be prioritized and preferably sent at intervals until the testing is performed and reported. In addition, educational messages relating to the risks of failing to test as recommended would be prioritized and frequency of sending other educational messages can be controlled by an optimization procedure;
when the patient fails to take the recommended action with respect to eating or exercising (or fails to report that they complied with the recommended diet or exercise actions), advisory messages from category (ii) (in the Summary) would be prioritized and preferably sent at intervals until the action is performed and reported. In addition, educational messages relating to the risks of failing to diet and exercise as recommended would be prioritized. Other educational messages could also be prioritized based on other factors, and frequency of sending them can by controlled by an optimization procedure; and
when the patient fails to take or report the recommended action as set forth in category (iii) (in the Summary), advisory messages from category (iii) would be prioritized and preferably sent at intervals until the action is performed and reported. In addition, educational messages relating to the risks of failing to act as recommended would be prioritized and other educational messages could also be prioritized based on other factors, and frequency of sending them can by controlled by an optimization procedure.

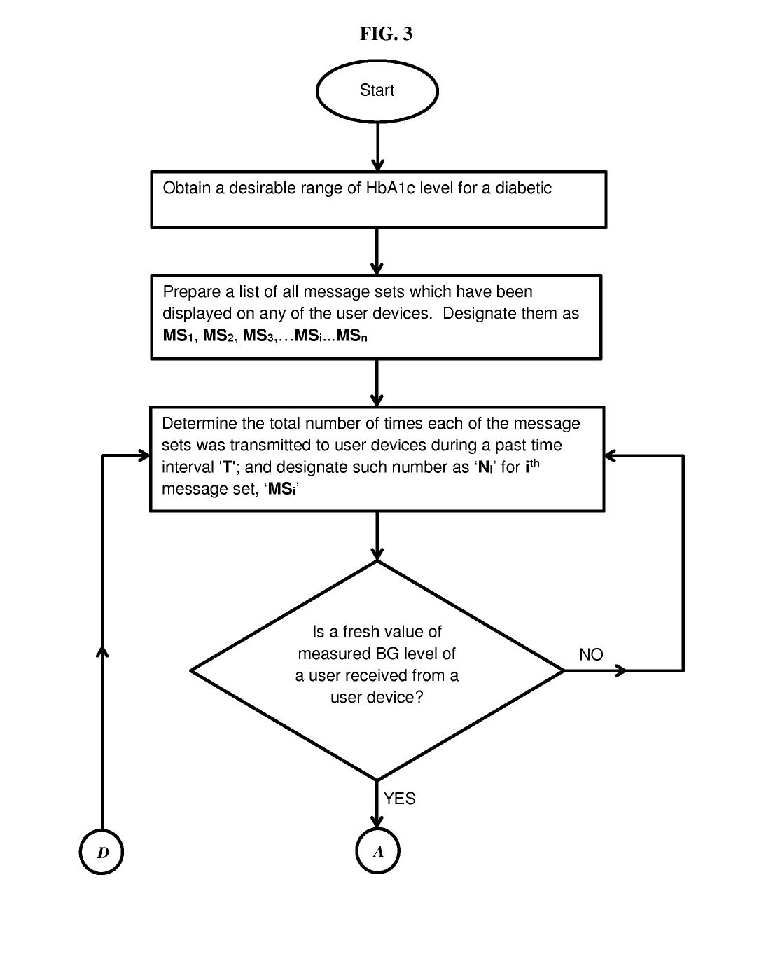

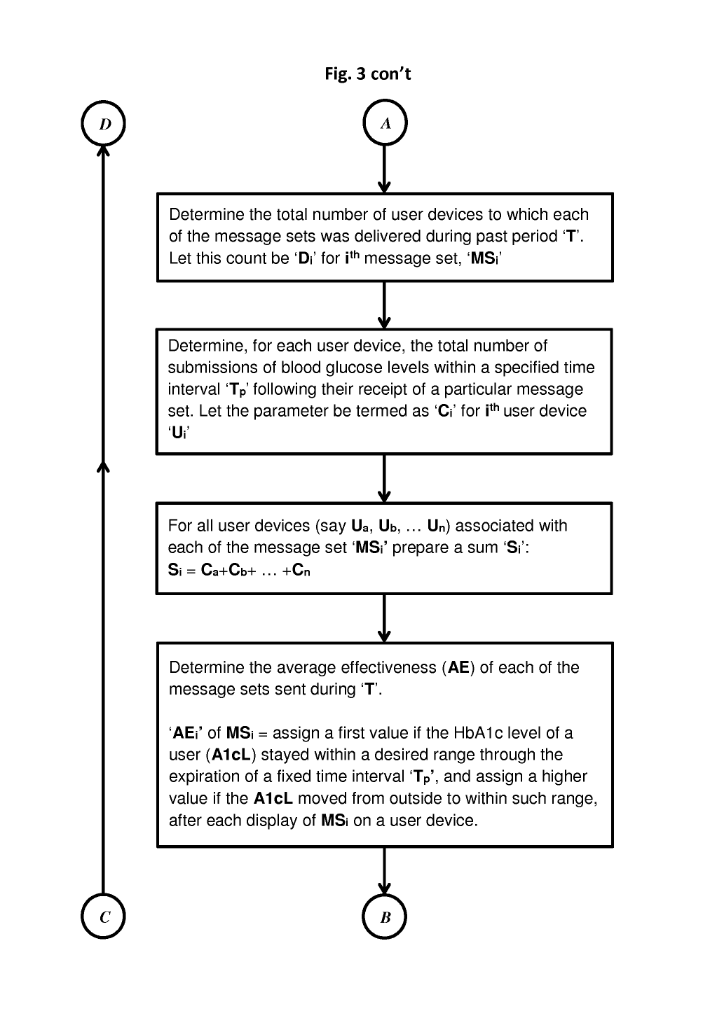

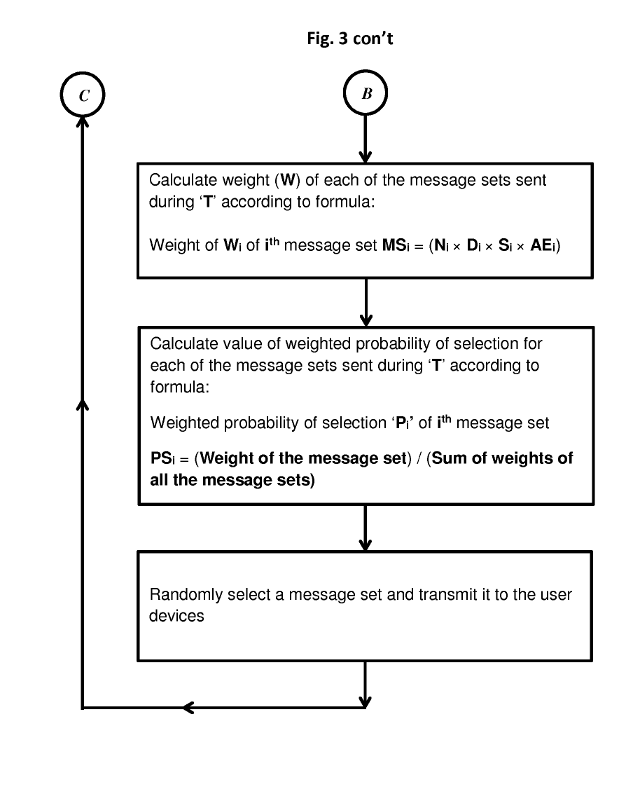

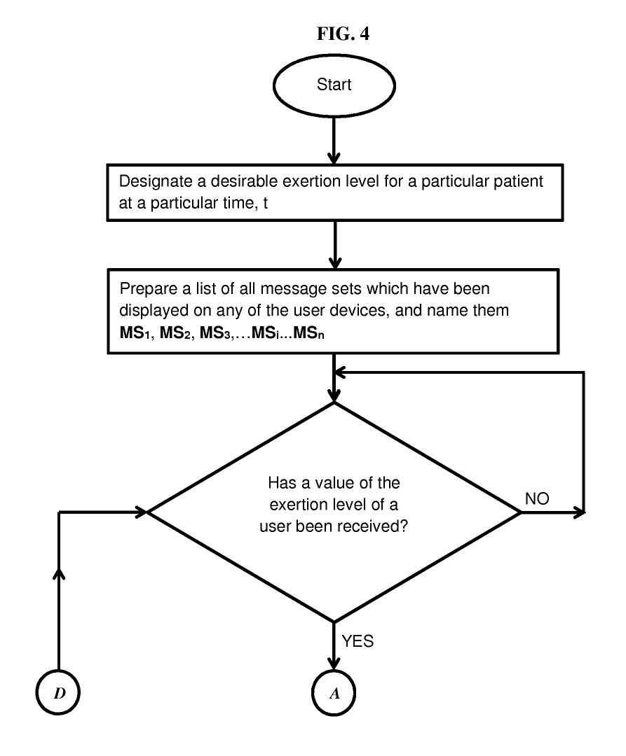

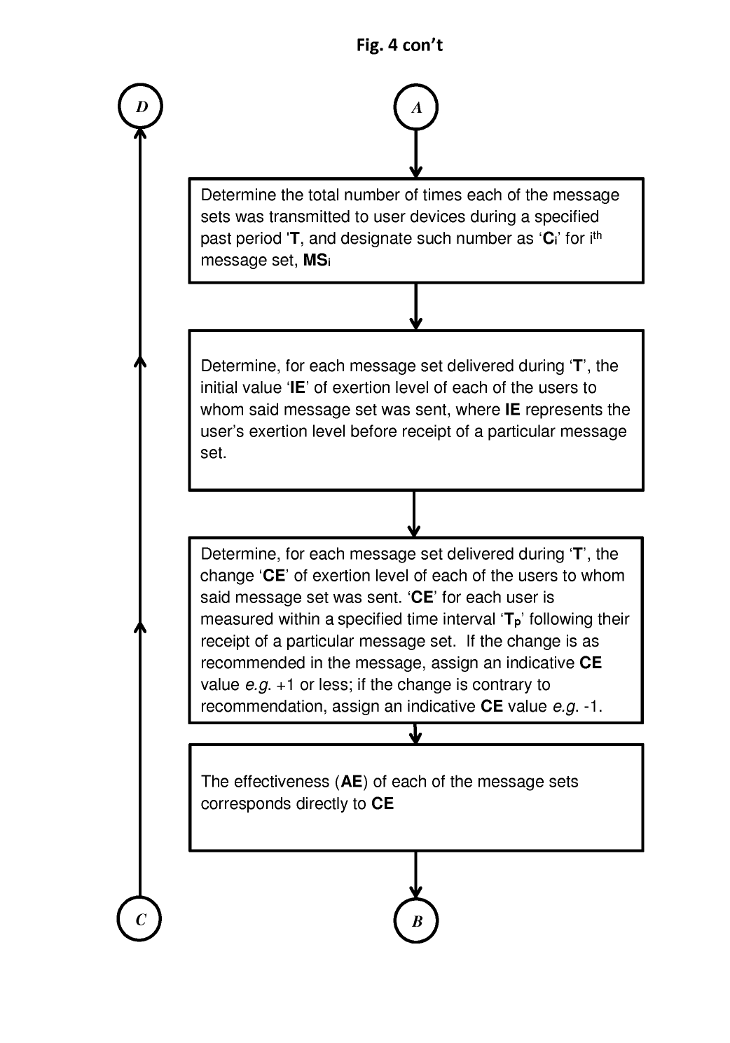

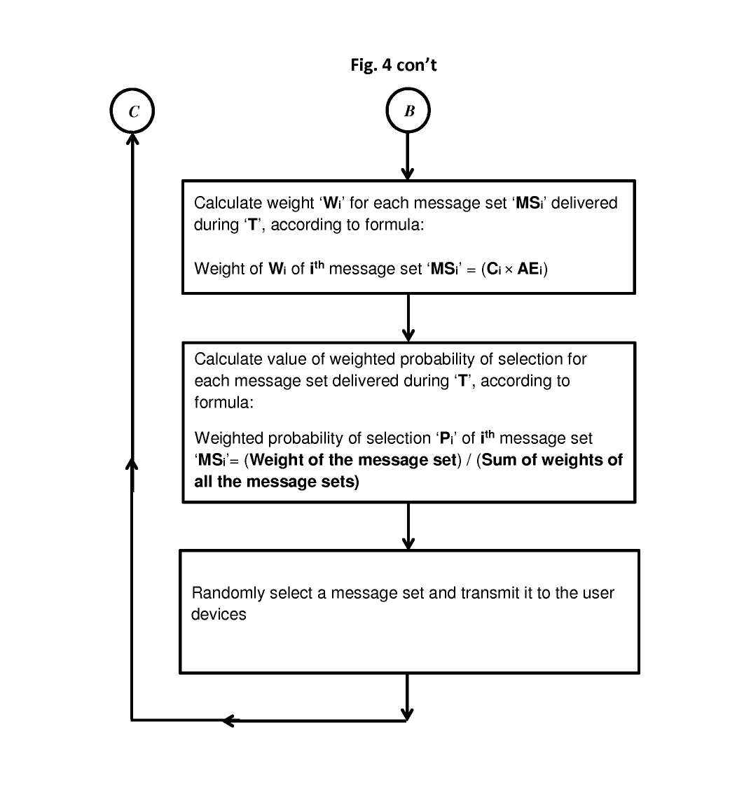

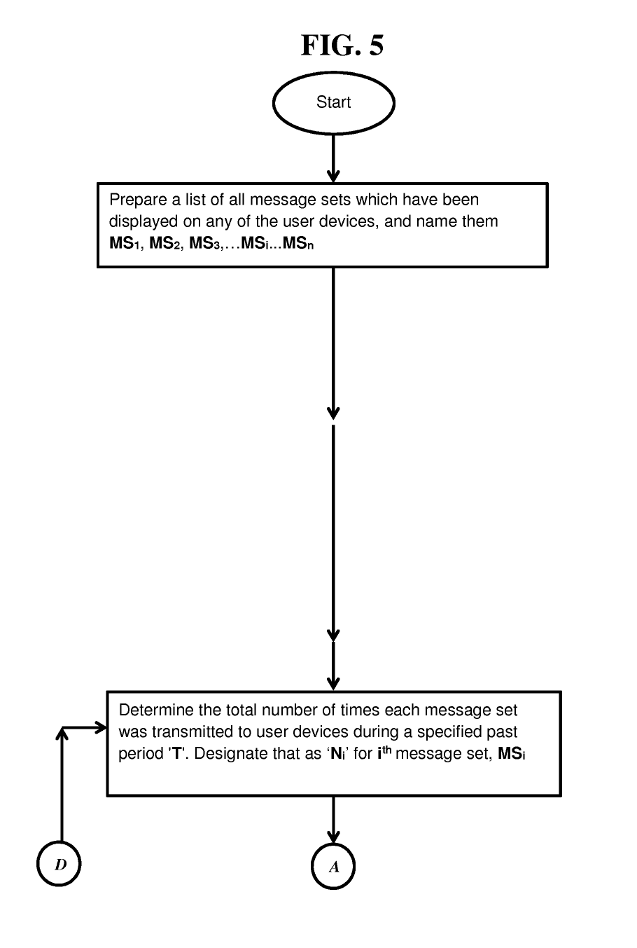

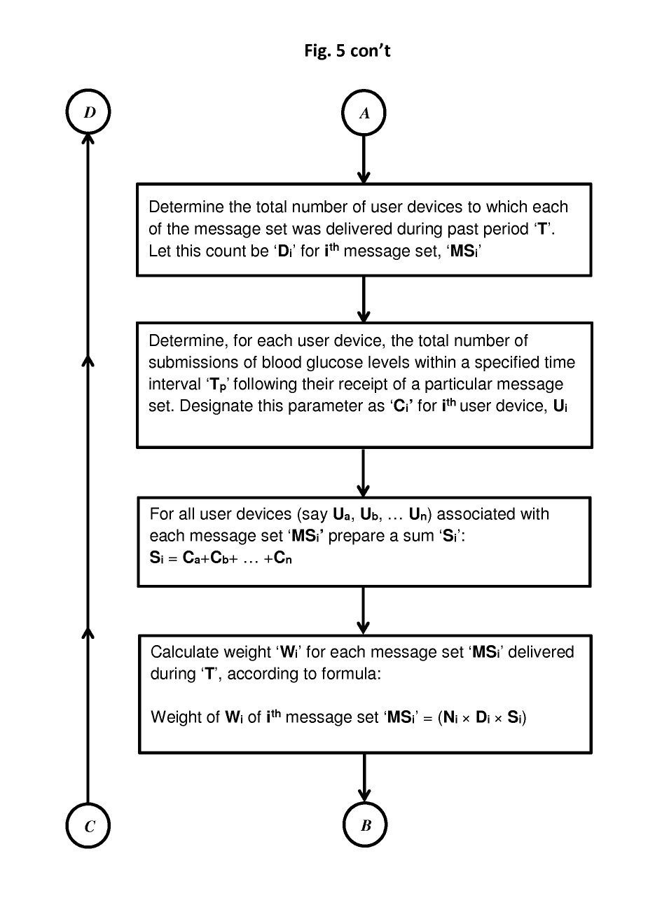

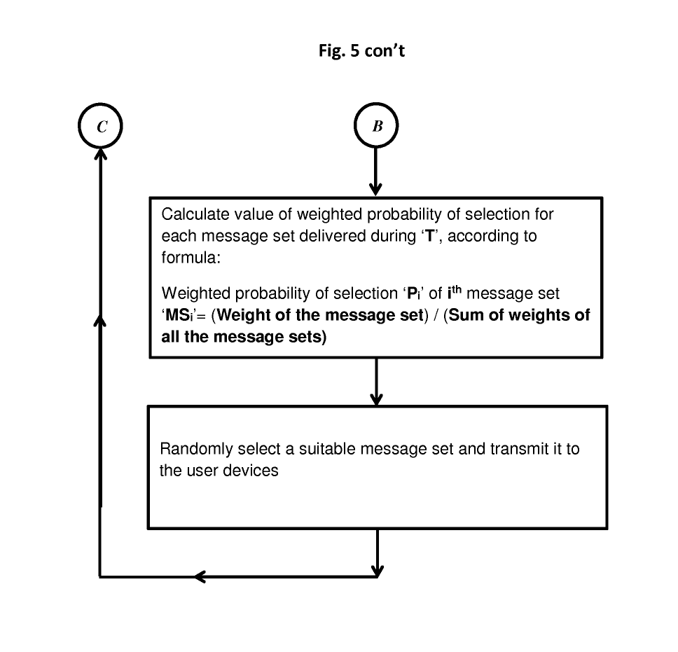

Turning to controlling frequency of message selection using, e.g., optimization through weighting, the weighting of messages (and/or other method of controlling their frequency of selection) can be set initially but is expected to change over time based on the effectiveness of the message in prompting the desired patient response to it (see FIGS. 1 to 5 herein and U.S. application Ser. No. 14/307,906, incorporated by reference). The patient response to messages can be objectively determined based on the response as determined by subsequent BG levels or levels of other indicators, based on patient exertion level (as measured and reported by the patient or as measured and automatically reported by a pedometer or accelerometer carried by the patient), patient diet (as reported by the patient), or based on clinical endpoints including death or diabetic disease markers, including non-healing wounds, hypertension, neuropathy, nephropathy, stroke, gastroparesis, ulcers, heart disease, and cataracts. Such responses can be used to optimize the messages sent to the patient, as described in U.S. application Ser. No. 14/307,906 (where the optimization is achieved through sending a message to users, weighting based on the effectiveness in prompting patient responses desired, randomly selecting the weighted messages and again determining effectiveness, and repeating the cycle so optimization is continuous). See also FIGS. 1 to 5 herein, showing weighting and optimization schemes for optimizing messages relating to control of HbA1c level, of exertion level and of frequency of testing for blood glucose level.

As noted above, prioritization includes increasing the frequency of sending messages, which can be based on any of the factors noted above. In some cases (particularly, where a recommended action is not required for patient health, e.g., changes in food or exercise preferences rather than food or exercise prohibitions) the frequency of sending certain messages can be decreased (a type of deselection) based on the same factors which lead to message deselection.

An exemplary table below shows the prioritization and deselection of messages described above:

TABLE I
Prioritizing and De-Selecting Messages in a Message Bank

For each message: Raise the probability of it being sent; or, lower the probability of it being sent,
by placing it in one or more of the following categories (where each category is tied to a
particular time or event, designated “X” below, though X normally indicates different time
periods and events for each of the categories below):
(i) Absolute Prioritized messages = Always sent, until X [X = event or time] stop sending;
(ii) Absolute Deselected messages = Never sent, until X [X = event or time] start sending;
(iii) Prioritize message frequency: whereby it's sent at frequency X, until X [X = event or time],
then change frequency; and
(iv) Deselect message frequency: whereby it's sent at frequency no greater than X, until X [X =
event or time], then change frequency.
Raise or lower the frequency of sending a particular message by, e.g., changing the probability of
a particular message being sent by weighting and re-weighting based on effectiveness, or
otherwise optimizing the effectiveness of the messages sent based on one or more of: patient
responses, objective measures of e.g. exertion level, chemical indicators or clinical outcomes.

As noted above, prioritization or deselection of certain educational messages often depends on the prioritization or deselection of advisory or other types of messages. Prioritization or deselection of advisory and other message types (besides educational messages) is also often controlled by the placement of certain messages in one of the categories in Table I. These categorizations of message types is set forth in Table II below.

TABLE II
Prioritizing and De-Selecting Messages in a Message
Bank Where Messages Are Differentiated by Message Type

```
Message types:
    (i) Messages Recommending Patient Action
    (ii) Messages Recommending Data Input by Patient
    (iii) Messages Acknowledging Performance of Recommended
    Action or Input
    (iv) Educational Messages
Messages of each type above are prioritized or de-selected based on
placing a message in one or more the categories set forth in Table I.
Placement of a particular message in one of the categories in Table I
determines the placement of certain other messages (of the same or
of a different type) in one of the categories in Table I.
```

As noted in Table II, placement of a particular message in one of the categories in Table I determines the placement of certain other messages (of the same or of a different type) in one of the categories in Table I. A number of exemplary messages of all four types in Table II are set forth in US Publ'n Nos. 20130035563 and 20120231431 (both incorporated by reference).

As a first example, certain educational messages will nearly always change their Table I category when another message type changes its Table I category. For example, when BG or HbA1c levels move far out of range (hyperglycemia or hypoglycemia), messages of type (iii) in Table II which praise the patient's actions will be absolutely deselected (until the hyperglycemia or hypoglycemia is rectified). In such case, messages of type (i) specifying how to rectify the hyperglycemia or hypoglycemia will be prioritized, and educational messages (type (iv)) outlining the risks of hyperglycemia or hypoglycemia, as applicable, will also be prioritized. Other educational messages discussing the benefits of maintaining BG and/or HbA1c levels within the desired range may be concomitantly prioritized or deselected.

Preferably, prioritizing and deselecting educational messages discussing the benefits of maintaining BG and/or HbA1c levels at the desired range is controlled by their effectiveness in accomplishing such objective. The effectiveness of educational messages can be determined using the weighting and re-weighting procedure set forth in FIGS. 1 to 5, or by other similar optimization procedures or other algorithms (readily apparent to those skilled in the art).

To determine long term effectiveness of educational messages on long term clinical outcomes or longer term control of indicators including HbA1c level, one simply picks a greater value for “T” in FIGS. 1 to 5, and then re-weights. FIGS. 1 to 5 set forth an optimization process, where all messages are tested periodically. The last box in each of FIGS. 1 to 5 requires random selection of a message, though the messages in the message bank selected from have been weighted. This means that the less effective, lower weighted messages are still selected and sent, though at a lower frequency than messages with a higher weight.

The optimization of messages according to FIGS. 1 to 5 could be over the entire spectrum of users, or a subset thereof (based on criterion including education level, ethnicity, severity of disease, first language), or even for an individual—where the user is the only person the messages are optimized against, and the user's responses determine which messages are sent more frequently. Effectiveness of messages for an individual patient, or a sub-group of patients, can be determined by viewing only the messages sent to them and their response(s), under the process outlined in FIGS. 1 to 5. For individual optimization under the procedures in any of FIGS. 1 to 5, the number of users should be set at “1” for the user for whom the messages are being optimized.

The optimization process outlined in FIGS. 1 to 5 is a continuous prioritization and deselection process, in which it is anticipated that effectiveness of messages can change over time; and therefore, their frequency changes to try to compensate for any decreasing or increasing effectiveness. Again, messages can then be optimized for a sub-group or an individual as noted above, if their effectiveness changes for such sub-group or individual.

The optimization process outlined in FIGS. 1 to 5 is a “pure optimization” embodiment, where iterative optimization (through weighting) controls the selection of all messages, based on message effectiveness. In a partial optimization embodiment, the optimization procedure would be used to determine message effectiveness, and then a message prioritization and deselection procedure can be instituted to select and avoid certain messages, which are to be sent in connection with those messages found to be most effective. As an example of partial optimization, if a certain group of messages are found best-suited for avoiding hypoglycemia through optimization, then other messages relating to avoiding hypoglycemia can be deselected. In a pure optimization procedure, such other messages would receive lower weight and be sent less often than more effective messages, but would nevertheless be sent occasionally.

A partial optimization procedure can also be used where patient preferences are changed. As an example of such case, the messages which are most effective in prompting patient compliance with BG testing, HbA1c maintenance in a desired range, diet or exercise regimens can be identified by an iterative optimization procedure. After the optimized messages are determined, they would be examined against the patient preferences, and those in conflict, would be deselected. Similarly, certain messages which supported or were consistent with the user's preferences but which were not selected through optimization, could be prioritized.

In a partial optimization procedure, changing the frequency with which a message in categories (i), (ii) or (iii) of Table II is sent, generally brings about a change in sending frequency (through the optimization process or through prioritization or deselection) of an educational message in category (iv) of Table II as well. In the case, for example, where a patient's preferences change, so that certain foods and exercise types are deselected, certain educational messages (e.g., those touting the benefits of the deselected foods or exercise types) can also be deselected. Or, certain educational messages (e.g., those touting the benefits of doing more activity if the patient prefers to eat more carbohydrates) can be prioritized and sent at increased frequency.

A partial optimization procedure can include optimizing the frequency of sending of particular messages, where the optimal frequency is selected based on patient response. This means that sending certain messages at a specified frequency (not more or less than) leads to optimal patient responses. The responses can be measured over varying time periods, and optimization can be otherwise carried out as shown generally in FIGS. 1-5.

Other messages which appear to require “pure prioritization,” can in fact also account for patient preferences. Messages relating to administration of medication may be effectively fixed by prescription requirements. But in diabetes, many medications, including insulin, are administered in response to BG levels or patient feelings, meals and meal times and other indicia. Thus, messages relating to medication can, as a first step, be prioritized or deselected in relation to such patient indicia and also, possibly, in relation to patient preferences. For example, patients may wish to administer insulin only at certain times of the day or only before or after meals.

Similarly, messages relating to patient-specific advice can be prioritized for that patient, and other messages can be conformed to that advice by prioritization or deselection. The advice can be any action to reduce risk of morbidity (checking indicators or patient feelings) or control biometric indicators (including BG and/or HbA1c level) or increase patient well-being. The effectiveness of other messages can be optimized in view of the new message choices (after prioritization and deselection), and in such case the optimization of such other messages is preferably individualized.

The specific methods, processes and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. Thus, for example, in each instance herein, in embodiments or examples of the present invention, any of the terms “comprising”, “including”, containing”, etc. are to be read expansively and without limitation. The methods and processes illustratively described herein suitably may be practiced in differing orders of steps, and that they are not necessarily restricted to the orders of steps indicated herein or in the claims. It is also noted that as used herein and in the appended claims, the singular forms “a,” “an,” and “the” include plural reference, and the plural include singular forms, unless the context clearly dictates otherwise. The term “messages” includes “message sets.” Under no circumstances may the patent be interpreted to be limited to the specific examples or embodiments or methods specifically disclosed herein. Under no circumstances may the patent be interpreted to be limited by any statement made by any Examiner or any other official or employee of the Patent and Trademark Office unless such statement is specifically and without qualification or reservation expressly adopted in a responsive writing, by Applicants. The invention has been described broadly and generically herein. Each of the narrower species and subgeneric groupings falling within the generic, disclosure also form part of the invention.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A process of increasing diabetic patient compliance with a recommended diet and exercise regime, comprising:
providing a recommended diet and exercise regimen for the patient to follow for a particular forthcoming period;
providing an interactive wireless link between a server and a device carried by the patient:
(i) wherein the device is actuated by the patient to test a patient blood sample for patient blood glucose level and the device determines patient exertion level by measuring patient movement or acceleration and the device actively sends the determinations of said blood glucose level and exertion level to the server, and where the device or the server actively queries the patient about prior food consumption and time of food consumption,
(ii) wherein the server analyzes the blood glucose level test results, exertion level and query responses, determines an estimated HbA1c level for the patient, and based on the results of said analysis and of said determination, sends the patient advisory messages about future food consumption and timing of food consumption, about timing of further testing, and also sends the patient advisory messages about commencing, continuing or ceasing exertion, and also sends the patient advisory messages about the benefits or detriments of particular diet and exercise choices;
weighting the advisory messages based on their average effectiveness in moving patients to diet and exercise in a manner which moves their estimated HbA1c level into a desired range or maintains their estimated HbA1c levels in a desired range, wherein averaged effectiveness is the effectiveness of particular messages in causing patients to take actions which make their estimated HbA1c levels move into a desired range or which cause users to take actions which maintain their estimated HbA1c levels in a desired range over the number of times said particular messages are displayed on the patient's device;
selecting messages frequency of display on the patient's device in accordance with the respective weight of the selected messages; and
repeating the weighting of messages based on their average effectiveness and the selection of messages for display in accordance with the respective weight of the selected messages.

2. The process of claim 1 wherein messages below a certain weight are not sent.

3. The process of claim 1 wherein the repeating step is repeated several times based on the average effectiveness of messages sent.

4. The process of claim 1 wherein the particular messages include message groups, where a message group includes messages regarding food intake, timing of food intake, ceasing or commencing exercise and messages relating to the benefits or detriments of particular diet and exercise choices.

5. The process of claim 4 wherein the particular messages include only message groups about the benefits and detriments of particular diet and exercise choices.

6. The process of claim 1 wherein the desired range of BG level is 90 to 125 mg/dL.

7. The process of claim 1 wherein the desired range of BG level is 90 to 180 mg/dL.

8. The process of claim 1 wherein the desired range of HbA1c level is 5 to 6%.

9. The process of claim 1 wherein during the selection process, messages are ranked in order of their weight by the server.

10. The process of claim 1 wherein if the BG level is outside a specified range, the server also selects particular messages for display to the user without regard to their weight.

11. A process of selecting particular messages for display to diabetic patients which are most effective in moving diabetic patients to diet and exercise in a manner which moves their blood glucose level towards a desired range or maintains their blood glucose levels in a desired range, comprising:
providing a recommended diet and exercise regimen for the patient to follow for a particular forthcoming period;
providing an interactive wireless link between a server and a device carried by the patient,
(iii) wherein the device is actuated by the patient to test a patient blood sample for patient blood glucose level and the device actively determines patient exertion level by measuring patient movement or acceleration and the device sends the determinations of said blood glucose level and exertion level to the server, and where the device or the server actively queries the patient about prior food consumption and time of food consumption,
(iv) wherein the server analyzes the blood glucose level test results, exertion level and query responses, and sends the patient advisory messages about future food consumption and timing of food consumption, and also sends the patient advisory messages about commencing, continuing or ceasing exertion, and also sends the patient advisory messages about the benefits or detriments of particular diet and exercise choices;
weighting the advisory messages based on their average effectiveness in moving patients to diet and exercise in a manner which moves their estimated HbA1c level into a desired range or maintains their estimated HbA1c levels in a desired range, wherein: averaged effectiveness is the effectiveness of particular messages in causing patients to take actions which make their estimated HbA1c levels move into a desired range or which cause users to take actions which maintain their estimated HbA1c levels in a desired range over the number of times said particular messages are displayed on the patient's device;
selecting the probability of display of particular messages on the patient's device in accordance with the respective weight of the selected messages such that only messages with greater than a designated average effectiveness are displayed or such that messages having greater weight are displayed more often; and
repeating the last two steps of weighting the advisory messages based on their average effectiveness and of selecting particular messages for display.

11. The process of claim 10 wherein the particular messages selected are combinations of advisory messages about future food consumption and timing of food consumption, about timing of further testing, about commencing, continuing or ceasing exertion, and about the benefits or detriments of particular diet and exercise choices.

12. The process of claim 10 wherein the particular messages selected are advisory messages about the benefits or detriments of particular diet and exercise choices.

13. The process of claim 10 wherein the particular messages selected are sent in a particular sequence and over a particular period.

14. The process of claim 10 wherein the particular messages selected advise taking the same actions or advise about the same benefits or detriments as messages not selected.

15. The process of claim 10 wherein the server also sends the patient advisory messages about the timing of further blood glucose level testing.

16. The process of claim 15 wherein average effectiveness of said advisory messages about timing or the frequency of the patient's blood glucose testing is determined.

17. The process of claim 16 wherein particular advisory messages about timing which have the greatest average effectiveness in moving patients to test their blood glucose are sent by the server more frequently than others.

18. The process of claim 16 wherein the advisory messages about timing are weighted based on their average effectiveness in moving patients to test their blood glucose and those messages with the greatest weight are sent more frequently than others.

19. The process of claim 1 wherein if the BG level is outside a specified range, the server also selects particular messages for display to the user without regard to their weight.
